(19) United States
(12) Patent Application Publication
(10) Pub. No.: US 2012/0324260 A1
(43) Pub. Date: Dec. 20, 2012

(54) ELECTRONIC APPARATUS FOR SAVING POWER, AND METHOD OF SAVING POWER IN AN APPARATUS

(76) Inventors: Hideo Kezuka, Fuchu-shi (JP); Takuya Shiki, Fukaya-shi (JP); Hideyuki Toma, Kodaira-shi (JP)

(21) Appl. No.: 13/398,544

(22) Filed: Feb. 16, 2012

(30) Foreign Application Priority Data
Jun. 14, 2011 (JP) 2011-132530

(51) Int. Cl. G06F 1/32

(52) U.S. Cl. 713/320

(57) ABSTRACT

According to one embodiment, a transceiver acquires actual consumption data and predicted consumption data for each time slot, from a power supply management system. A data analysis block analyzes the actual consumption data and the predicted consumption data, and generates graph data representing a graph showing a result of the analysis. A display control block causes a display device to display the graph and a power-save line in the graph. A power-save line control block moves the power-save line to a desired position and utilizes a value associated with the desired position as a value at which to start power saving. A command signal output block outputs a power-save command signal to an apparatus which should save power, if the actual consumption data and/or the predicted consumption data exceed the value indicated by the power-save line.

### CROSS-REFERENCE TO RELATED APPLICATIONS

This application is based upon and claims the benefit of priority from prior Japanese Patent Application No. 2011-132530, filed Jun. 14, 2011, the entire contents of which are incorporated herein by reference.

### FIELD

Embodiments described herein relate generally to an electronic apparatus for saving power and a method of saving power in an apparatus.

### BACKGROUND

Various control circuits for saving power in electronic apparatuses, such as personal computers, have been proposed. For example, a portable receiver of a power-saving type has been proposed, the portable receiver receives a twelve-segment broadcast signal while being driven with commercially available power, and receives a one-segment broadcast signal while being driven by a battery, thus saving power.

In recent years, much attention has been paid to various schemes of saving power supplied from the power generation plants of electric power companies. If the power consumed in the district to which a power generation plant supplies power is excessive, a blackout will occur, possibly resulting in damage to the factories, hospitals, etc. in the district.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing a representative overall configuration of a television receiver that incorporates an embodiment;

FIG. 2A and FIG. 2B are exemplary diagrams outlining a representative configuration of a remote controller;

FIG. 3 is an exemplary flowchart explaining how the television receiver of FIG. 1 operates;

FIG. 4A, FIG. 4B and FIG. 4C are diagrams, respectively showing an exemplary message and exemplary icons the television receiver of FIG. 1 may display;

FIG. 5 shows an example of the time at which the reception state is switched from the full-segment receiving state to the one-segment receiving state, and an example of the time at which the image is actually switched from the full-segment image to the one-segment image;

FIG. 6A, FIG. 6B, FIG. 6C, FIG. 6D and FIG. 6E show exemplary images of the display while the television receiver of FIG. 1 is set in the power saving mode;

FIG. 7A and FIG. 7B show an exemplary structure of the backlight unit of the display of the television receiver of FIG. 1;

FIG. 8A and FIG. 8B show another structure the backlight unit of the display of the television receiver of FIG. 1 may have;

FIG. 9A and FIG. 9B show an exemplary power-saving menu the display of the television receiver of FIG. 1 may display, helping the user to set a power-saving function at the remote controller;

FIG. 10 is a diagram showing an exemplary setting menu the display of the television receiver of FIG. 1 may display, helping the user to select a power-save mode or a peak-shift mode;

FIG. 11A is a diagram showing a luminance indicator temporarily displayed when the television receiver starts operating on commercially available AC power;

FIG. 11B is a diagram showing a luminance indicator temporarily displayed when the television receiver is set to the peak-shift mode;

FIG. 12 is a diagram showing an outer appearance of a mobile terminal, and an exemplary data the mobile terminal displays;

FIG. 13 is a diagram showing the configuration of the mobile terminal;

FIG. 14 is a diagram showing the function blocks of the data processor incorporated in the mobile terminal;

FIG. 15 is a flowchart explaining the sequence of setting the functions in the mobile terminal;

FIG. 16 is a diagram showing another embodiment, explaining how the television receiver is set to a power saving mode;

FIG. 17 is a diagram showing still another embodiment, explaining an operation of the television receiver or the mobile terminal;

FIG. 18A is a diagram showing how data is transferred between the mobile terminal and a server;

FIG. 18B is a diagram showing exemplary data items the mobile terminal may display; and

FIG. 19 is an exemplary image of the display which is to explain how the user operates the mobile terminal or the television receiver, in accordance with a power-consumption predict data displayed by the display.

### DETAILED DESCRIPTION

Various embodiments will be described hereinafter with reference to the accompany drawings.

In general, according to one embodiment, there are provided an electronic device and a method, both able to adaptively control the power saving in an apparatus (e.g., television receiver, air conditioner, refrigerator, and other household appliances) in monitoring the amount of actually power supply from the power generating plant.

According to an embodiment of the present disclosure, an electronic apparatus is provided. The apparatus comprises: a transceiver configured to acquire actual consumption data and predicted consumption data for each time slot, from a power supply management system; a data analysis block configured to analyze changes of the actual consumption data and the predicted consumption data and to generate graph data representing a graph showing a result of the analysis; a display control block configured to cause a display device to display the graph and a power-save start line in the graph; a power-save start line control block configured to move the power-save start line to a desired position and to utilize a value associated with the desired position as a value at which to start power saving; and a command signal output block configured to output a power-save command signal to an apparatus which should save power, if the actual consumption data and/or the predicted consumption data exceeds the value indicated by the power-save start line.

An embodiment will be described with reference to the drawings.

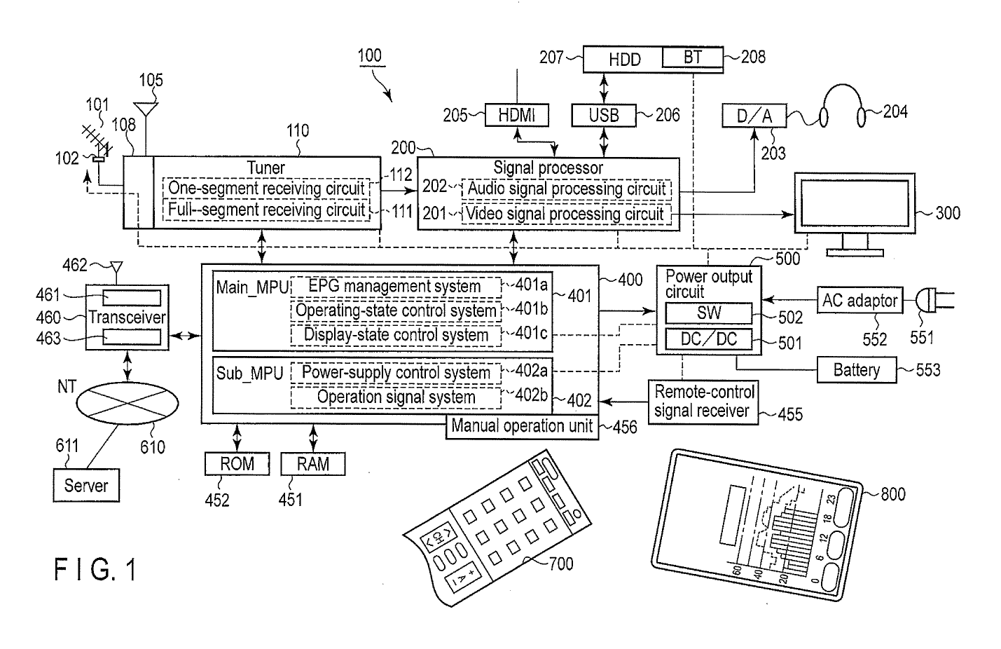

FIG. 1 shows a stationary television receiver 100 to which the embodiment is applied. A UHF antenna 101 can catch terrestrial television broadcast waves. Power is supplied to the booster 102 of the antenna 101. The existing terrestrial digital broadcasting system can transmit a twelve-segment (it may be referred to a full-segment or a full-seg) broadcast signal and a one-segment (it may be referred to one-seg) broadcast signal. The UHF antenna 101 is used to receive the full-segment broadcast signal. An indoor antenna 105 is used to receive the one-segment broadcast signal.

The UHF antenna 101 may also be referred to an “external antenna” or “outdoor antenna.” The indoor antenna 105 may also be referred to an “internal antenna.”

The UHF antenna 101 can be connected to a tuner 110 via an antenna connection board 108. The indoor antenna 105 can be connected to the tuner 110 via the antenna connection board 108. In case, to use the indoor antenna 105 in place of the UHF antenna 101, the terminal of the UHF antenna 101 is pulled from the connector of the antenna connection board 108, and the terminal of the indoor antenna 105 is connected to the connector of the antenna connection board 108. Both the UHF antenna 101 and the indoor antenna 105 may be connected at all times to the two connectors of the antenna connection board 108, respectively. In this case, a changeover switch may be operated to connect either the UHF antenna 101 or the indoor antenna 105 to the tuner 110, so that the antenna selected may be used.

The tuner 110 includes a full-segment receiving circuit 111 and a one-segment receiving circuit 112. The full-segment receiving circuit 111 or the one-segment receiving circuit 112 is set to a signal receiving state in accordance with a control signal output from a control block 400. The control block 400 will be described later in detail.

The tuner 110 is operated to select a channel. The program signal of the channel selected in the tuner 110 is demodulated and input to a signal processor 200. The signal processor 200 includes a video signal processing circuit 201 and an audio signal processing circuit 202. The video signal processing circuit 201 decodes an encoded video signal to a base-band video signal. As encoding and decoding schemes, there are the Moving Picture Experts Group (MPEG) and H.264/Advanced Video Coding (AVC) system, etc., for example. The base-band video signal output from the video signal processing circuit 201 is supplied to a display 300.

The audio signal processing circuit 202 acquires an audio stream from the program signal and then decodes the audio stream. The decoded audio signal is supplied to a digital-to-analog converter 203 and converted to an analog audio signal which is supplied to a speaker 204. In the system of FIG. 1, the speaker 204 is shown as a headphone. The headphone can, of course, be replaced by a stationary speaker.

The signal processor 200 can be connected to an external apparatus under the control of the control block 400. The signal processor 200 can be connected by, for example, a high-definition multimedia interface (HDMI) 205 to an external data record/playback apparatus such as an optical disk player, for example a DVD or BD (trademark) player. The signal processor 200 can therefore receive playback signals from the external data record/playback apparatus and process these signals to generate video and audio output signals. Further, the signal processor 200 can transmit the signals used for recording to the external data record/playback apparatus.

Under control of the control block 400, the signal processor 200 also can be connected via a universal serial bus (USB) 206 to a hard disk drive (HDD) 207. The hard disk drive 207 incorporates a battery 208, and can keep operating for two to three hours upon a blackout by using the battery. Moreover, the hard disk drive 207 can supply power from the battery to some other blocks shown in FIG. 1 under the control signal.

The control block 400 includes a main microprocessor unit (hereinafter referred to as “main MPU”) 401 and a sub-microprocessor unit (hereinafter referred to as “sub-MPU”) 402. The main MPU 401 includes an electronic program guide management system (hereinafter referred to as an “EPG management system) 401a, an operating-state control system 401b, and a display-state control system 401c.

The components 400, 401 and 402 and the components 401a, 401b and 401c may be given names other than those specified above. They may be called, for example, “main control circuit”, “sub-control circuit”, “EPG processing circuit”, “operating-state control circuit” and “display-state control circuit”. Alternatively, they may be called “modules” or “blocks”. Their names specified above accord with the functions they perform. Instead, other names may be used, each indicating that two or more components are integrated or combined.

The EPG management system 401a acquires program data through the Internet or the program data contained in a broadcast signal, and generates program list data. The program list data can be stored in a random access memory (hereinafter referred to as “RAM”) 451. Further, the EPG management system 401a can cooperate with the display-state control system 401c to read the program list stored in the RAM 451 and output the same to the display 300. Moreover, the EPG management system 401a can correct and change in periodically the program data stored in the RAM 451.

The RAM 451 may be any memory in which data can be written and from which data can be read, and can therefore be a nonvolatile memory. The RAM 451 may, of course, store various data items (e.g., icons, warning messages, and channel numbers). A read only memory (ROM) 452 is connected to the control block 400, and stores various software items for use in the television receiver 100. The software is extended in, for example, the RAM 451, operating the television receiver 100 in accordance with signals and instructions the user has input.

In response to the state signals generated internally or supplied externally or to operation signals supplied externally, the operating-state control system 401b controls the blocks incorporated in the television receiver 100. The operating-state control system 401b can switch the tuner 110, from the one-segment receiving state to the full-segment receiving state, or vice versa. Further, the operating-state control system 401b can control the signal processing state in the signal processor 200. Still further, the operating-state control system 401b can control color adjustment, luminance adjustment, partial shut-off of power supply, and the like, automatically or manually in accordance with the conditions preset.

The display-state control system 401c can adjust the backlight of the display 300 and control the illumination area of the backlight. The display-state control system 401c can further control the luminance of the video signal, the image magnification and reduction and the motion of a display position.

The sub-MPU 402 includes a power-supply control system 402a and an operation signal system 402b. The operation signal system 402b receives an operation signal transmitted from a remote controller 700 through a remote-control signal receiver 455 and analyzes the operation signal. In accordance with the result of analyzing the operation signal, the operation signal system 402b controls the operating state of the television receiver 100. More precisely, the operation signal system 402b turns on or off the main power supply of the television receiver 100, activates or deactivates the main MPU 401 or gives commands to the sub-MPU 402. Operation signals come from not only the remote-control signal receiver 455, but also from a manual operation unit 456. When the manual operation unit 456 is operated by the user, an operation signal from the manual operation unit 456 is analyzed by the operation signal system 402b.

The power supply system of the television receiver 100 will be described. The commercially available AC power is supplied to a plug 551, and thence to an AC adaptor 552. The AC adaptor 552 rectifies the power, which is input to a power output circuit 500. The power output circuit 500 converts the output of the AC adaptor 552 to various DC voltages. If the AC adaptor 552 is not provided, the power output circuit 500 rectifies the commercially available AC power, generating DC voltages of various values.

Moreover, the power output circuit 500 can acquire power from a battery 553. The power output circuit 500 has a DC-to-DC converter 501 and a switch 502. The DC-to-DC converter 501 converts the DC voltage applied from the battery 553 to various DC voltages. Thus, the power output circuit 500 can generate DC voltages of various values.

Under the control of the power-supply control system 402a, the power output circuit 500 can switch the power-use state of the television receiver 100, from the use of commercially available power to the use of battery power, or vice versa. The power-use state can be switched when the switch 502 is controlled by the power-supply control system 402a.

A transceiver 460 is connected to the control block 400. The transceiver 460 includes a short-distance communication device 461. The short-distance communication device 461 can communicate with a mobile terminal 800 via an antenna 462. The transceiver 460 further includes a network communication device 463. The network communication device 463 is connected to a network 610, and can perform data communication with a server 611. The mobile terminal 800 may be one of various types, such as a mobile telephone. The mobile terminal 800 has, at least, a transceiver, a display, an operation unit and a signal processor and is small enough to carry.

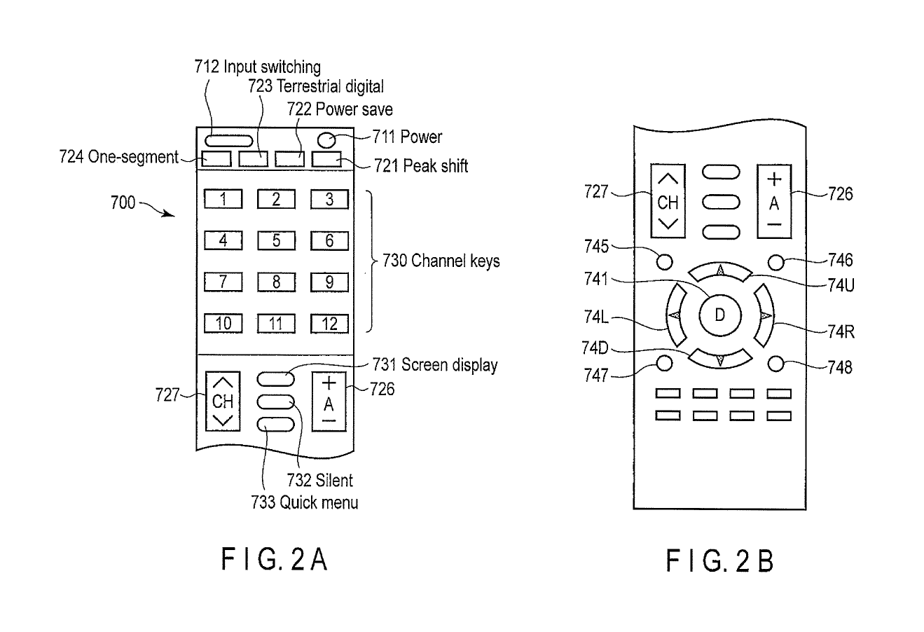

FIG. 2A and FIG. 2B shows the various buttons provided on the remote controller 700. The power button 711 may be pushed to turn on or off the television receiver 100. As the user repeatedly pushes the power button 711, the television receiver 100 is repeatedly turned on and off. Even if television receiver 100 is turned off state, the power output circuit 500 keeps supplying auxiliary power to the sub-MPU 402 and short-distance communication device 461. The sub-MPU 402 and short-distance communication device 461 can therefore receive operation signals from the remote controller 700. The input switching button 712 may be used to switch the television receiver 100 in a state of receiving an input from an external apparatus connected to the television receiver 100.

Assume that the input switching button 712 is repeatedly pushed. Then, the operating state of the television receiver 100 is cyclically changed to the digital-broadcast receiving state, the HDMI-signal receiving state, the video input state and the D-terminal input state. If the input switching button 712 is further pushed, the operating state of the television receiver 100 is changed back to the digital-broadcast receiving state.

The remote controller 700 has a peak-shift button 721, too. The peak-shift button 721 can be used to set the television receiver 100 to a power-save cooperation mode. In the power-save cooperation mode, the television receiver 100 saves the commercially available power (i.e., power supplied from the power generation plant of the electric power company). If the peak-shift button 721 is pushed while the television receiver 100 remains in the standby state, the television receiver 100 is switched to, for example, the battery-driven mode.

While the television receiver 100 is using the commercially available power, the display 300 displays a plug icon at the corner of the screen. While the television receiver 100 is using the battery power, the display 300 displays, at the corner of the screen, a battery icon that indicates the amount of power remaining in the battery 558. Note that the plug icon and the battery icon can have various shapes and can include characters, as long as they inform the user of the type of power supply now used.

The remote controller 700 further has a power-save button 722. When pushed, the power-save button 722 switches the television receiver 100 to a power saving state (or power saving mode). In the power saving mode, the screen of the display 300 becomes dark and the image-quality parameters are changed values, and power is thereby saved. More specifically, when the user pushes the power-save button 722, the luminosity of the backlight is decreased, thereby saving power. At the same time, the image parameters, such as black level, unicolor level and color temperature, are adjusted, displaying an image that is dark but can be seen well. When the power-save button 722 is pushed again, the screen of the display 300 acquires the standard brightness, and the image-quality parameters are changed back to the standard values.

The remote controller 700 also has a terrestrial digital broadcast button 723 and a one-segment button 724. When pushed, the terrestrial digital broadcast button 723 sets the television receiver 100 to the full-segment receiving mode. When pushed, the one-segment button 724 sets the television receiver 100 to the one-segment receiving mode. Once the television receiver 100 has been set to the one-segment receiving mode, the indoor antenna 105 is used to receive a one-segment broadcast signal, as explained with reference to FIG. 1.

The antenna may be automatically switched from the UHF antenna 101 to the indoor antenna 105, or vice versa, by a switch provided on the antenna connection board 108. As shown in FIG. 2A, the remote controller 700 has channel selection buttons 730, which are labeled “1” to “12,” respectively. The remote controller 700 further has a volume button 726 and a channel switching button 727. The volume button 726 is used to adjust the volume of the sound. The volume of the sound is increased when the “+” end of the button 726 is pushed. The volume of the sound is decreased when the “-” end of the button 726 is pushed. Every time the channel switching button 727 is pushed at the upper end (in FIG. 2A), the receiving channel of the TV may be changed to the immediately greater channel of the number. Every time the channel switching button 727 is pushed at the lower end (in FIG. 2A), the receiving channel of the TV may be changed to the immediately smaller channel of the number.

The remote controller 700 has buttons 731, 732 and 733 arranged in a column. If pushed, the button 731 causes the display 300 to display, temporarily, detailed data items such as the name and channel number of the broadcast station transmitting the program now received, the one-segment or full-segment receiving mode, and the type of video and audio data (monaural or stereophonic). If pushed, the button 732 labeled “silence button” causes the speaker 204 to stop outputting sound. If pushed, the button 733 labeled “quick menu” causes the display 300 to display a quick menu. The quick menu includes various image-setting items, sound-setting items, power-saving items and reception-setting items, etc. While looking at the quick menu displayed, the user moves a cursor in the screen of the display 300, to any desired item, and then pushes a select button 741 provided on the remote controller 700, thereby selecting the desired item. The display 300 then displays the item selected, in detail.

The remote controller 700 further has buttons 74L, 74R, 740 and 74D, which the user may control to move the cursor in the screen of the display 300. More precisely, if the buttons 74L, 74R, 74U and 74D are pushed, the cursor moves leftward, rightward, upward and downward, respectively, on the screen of the display 300. The select button 741 may be pushed to determine the desired item the cursor points to on the screen of the display 300.

The remote controller 700 still further has buttons 745, 746 and 747. If the button 745 is pushed, the display 300 will display a menu of image. If the button 746 is pushed, a program table is displayed. If the button 747 is pushed, the television receiver 100 will be set back to the previous operating mode.

### <Terrestrial Digital Broadcast Button 723 and One-Segment Button 724>

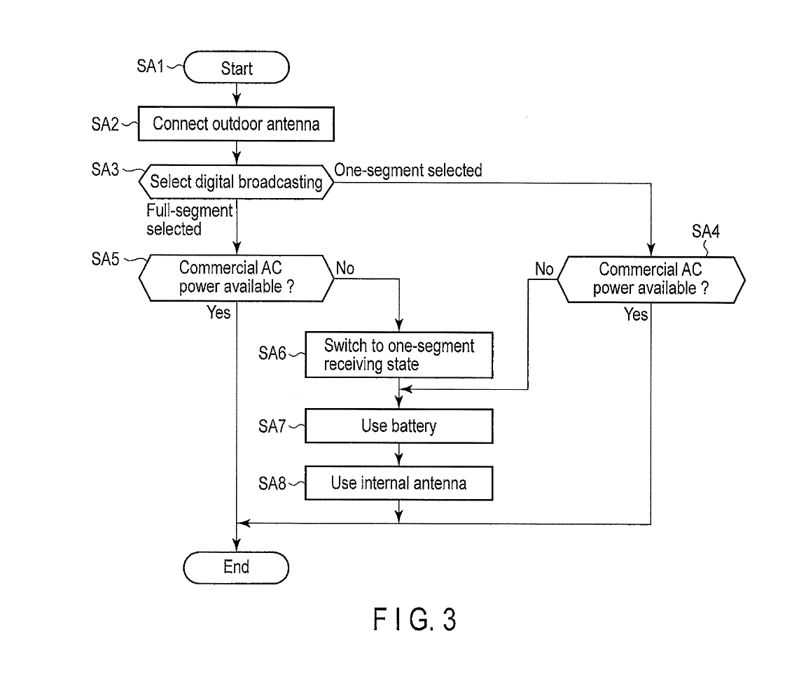

FIG. 3 shows how the television receiver 100 operates when it is switched from the one-segment receiving mode to the full-segment receiving mode, or vice versa. Assume that the receiving mode is switched to the one-segment receiving mode while the external antenna remains connected to the tuner 110 (Steps SA1 to SA3). This switching is achieved by a signal the user has input at the remote controller 700, a signal manually generated, or a signal automatically generated by a timer or in accordance with power-save data.

When the receiving mode is switched to the one-segment receiving mode, it is determined whether the commercially available AC power is supplied to the television receiver 100 (Step SA4). If the commercially available AC power is supplied to the television receiver 100 (YES in Step SA4), the process is terminated while the television receiver 100 remains in the one-segment receiving mode. If the commercially available AC power is not supplied to the television receiver 100 (NO in Step SA4), the process goes to Step SA7, in which the battery 553 is used. Then, the internal antenna 105 is used (Step SA8).

The process then returns to Step SA3, and if the full-segment reception is selected, the television receiver 100 is set to the full-segment receiving mode. In the full-segment receiving mode, it is frequently checked as to whether the commercially available AC power is supplied to the television receiver 100 (Step SA5). As long as the commercially available AC power is supplied to the television receiver 100, the full-segment reception continues. When the supply of the commercially available AC power stops, the television receiver 100 is automatically switched to the one-segment receiving mode (Step SA6). The battery 553 is therefore used (Step SA7), and the internal antenna 105 is used (Step SA8).

The user can thus switch the television receiver 100 to whichever receiving mode, i.e., full-segment receiving mode or one-segment receiving mode. Therefore, if the AC power supply is used, the user may set the television receiver 100 to the one-segment receiving mode, in order to save power.

Whether set in the full-segment receiving mode or the one-segment receiving mode, the television receiver 100 automatically assumes the one-segment receiving state and is battery-driven immediately, when the supply of the commercially available AC power is stopped. If a blackout should occur for some reason, the television receiver 100 would keep operating, giving audio-visual information to the user.

The battery 553 may be recharged at midnight, for example, when the power generation plant is generating more power than is necessary. In this regard, the television receiver 100 can display a recharging menu, which shows various time slots for recharging the battery 553. The user operates the remote controller 700, selecting the cursor on the screen of the display 300, and the select button 741, thereby selecting the desired time slot. Then, the battery 553 will be recharged in the time slot the user has selected, unless a blackout occurs in the time slot selected.

The television receiver 100 is so designed that the battery 553 is never recharged while it is displaying any program. That is, the power output circuit 500 can indeed supply the commercially available AC power to the battery 553, but supplies no AC power to the battery 553 as long as the television receiver 100 displays any program.

If the user pushes the peak-shift button 721, the battery 553 drives the television receiver 100. The battery 553 may be used in a power peak period such as a few hours in a summer afternoon. This use of the battery 553 helps prevent an increase in power consumption in the power peak period. Thus, whether the power peak period can be shifted or not, it is depends on whether the user selects a power peak shift button at an appropriate time.

Upon a blackout, no power is supplied to the booster 102 of the antenna 101, and the display 300 may not display the program. Even in this case, either an attached antenna or the indoor antenna 105 is utilized to achieve the one-segment reception at the event of a blackout. The television receiver 100 can be battery-driven for three hours, more or less.

Various measures can be taken to detect blackouts. The power-supply control system 402a is connected to, for example, a backup capacitor, and can keep operating for a prescribed time even if a blackout takes place. Therefore, the changes in the voltage on the power supply lines and the output of the AC adaptor 552 can be detected.

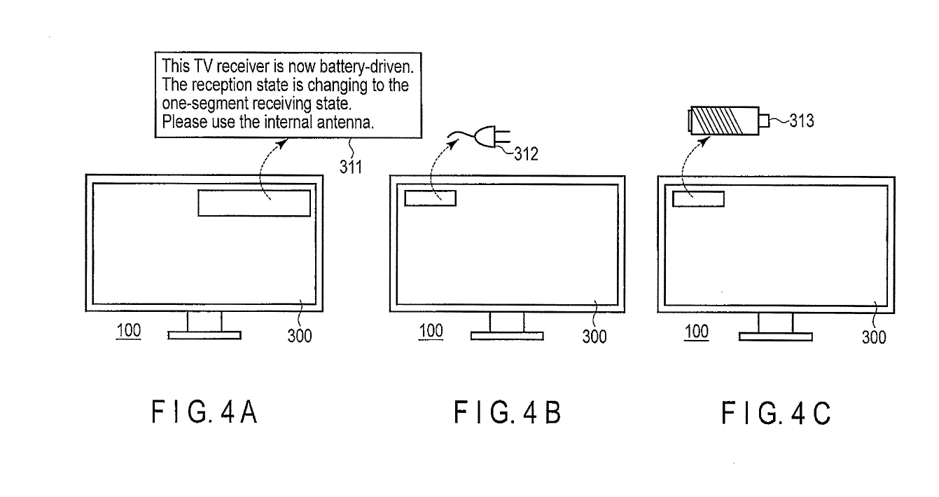

FIG. 4A shows an exemplary guidance message the display 300 displays when the power supply is switched from the commercially available AC power supply to the battery 553. At the time the power supply is switched to the battery 553, or at a blackout, the power supply to the booster 102 of the external antenna 101 is stopped, and the display 300 may no longer display the image. In this case, the display 300 displays a guidance message 311 of “This TV receiver is now battery-driven. The reception state is changing to the one-segment receiving state. Please use the internal antenna.” The term “internal antenna” may be replaced by “attached antenna” or “one-segment receiving antenna”.

FIG. 4B shows a plug-shaped icon 312 the display 300 displays while the television receiver 100 is using the commercially available AC power supply. FIG. 4C shows a battery-shaped icon 313 the display 300 displays while the television receiver 100 is using the battery 553. The battery-shaped icon 313 indicates the amount of power remaining in the battery 553. (More precisely, the number of slant lines is proportional to the power remaining in the battery 553.)

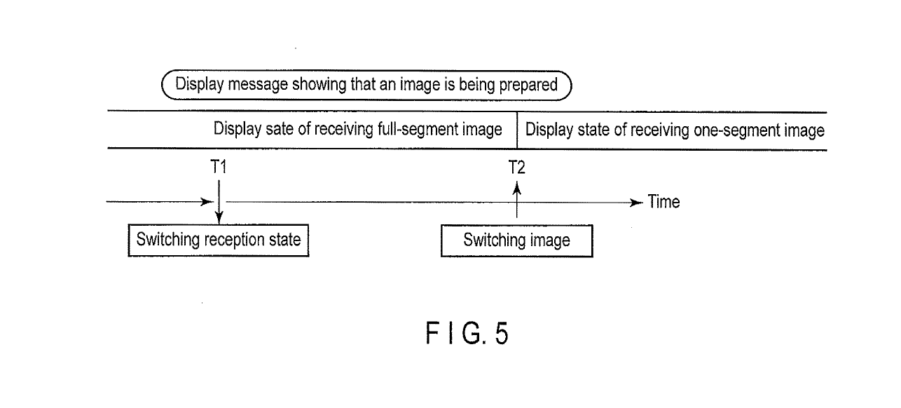

FIG. 5 shows time T1 at which the reception state is switched from the full-segment receiving state to the one-segment receiving state, and time T2 at which the image is actually switched from the full-segment image to the one-segment image. Some time lapses until a one-segment image is displayed after the reception state has been switched from the full-segment receiving state to the one-segment receiving state. Therefore, the full-segment image remains displayed on the screen until the one-segment video data is output. When the one-segment video data is output, the full-segment image is switched to the one-segment image on the screen of the display 300. Until the one-segment video data is output, a message showing this fact may be displayed on the screen of the display 300.

### <Peak Shift Button 721 and Power-Save Button 722>

The user may push the peak-shift button 721 to save the commercially available power (supplied from the power generation plant of the electric power company). If the peak-shift button 721 is pushed, the television receiver 100 stops using the commercially available power and starts using the battery 553. If the peak shift-button 721 is pushed while the battery 553 is being used, the television receiver 100 is set to the one-segment receiving state.

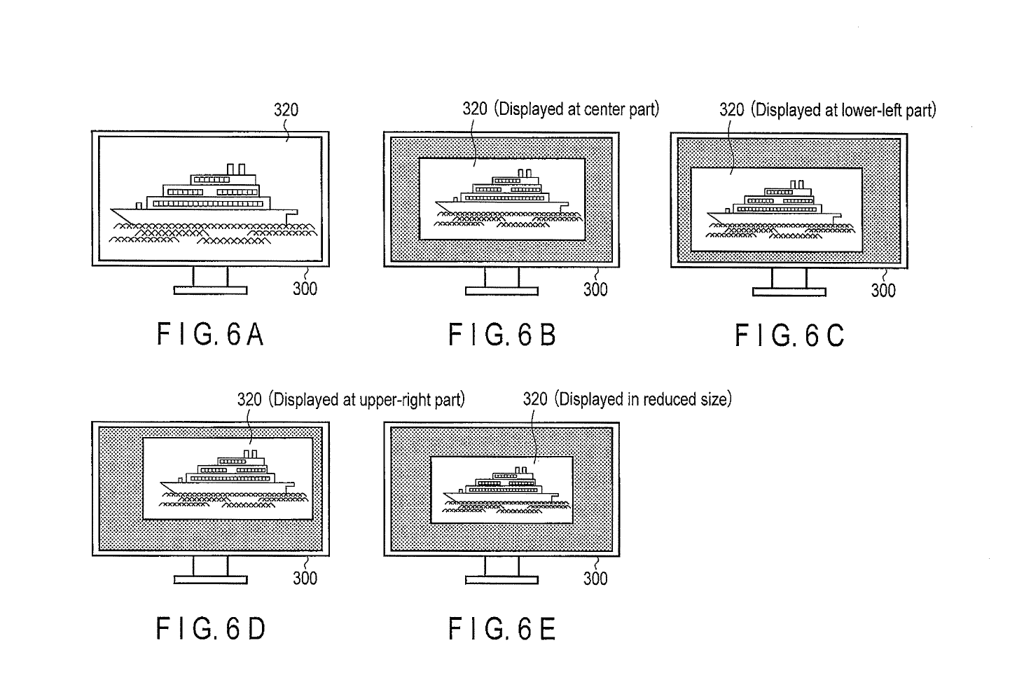

FIG. 6A to FIG. 6E show exemplary images the display 300 displays after the television receiver 100 has been set to the one-segment receiving state. Once set to the one-segment receiving state, the television receiver 100 can display an image 320 on the screen, as shown in FIG. 6A. In this state, the battery 553 is being used. So this state helps to save the power supplied by the electric power company. Further, in order to reduce the consumption of the battery power, the image can be displayed as shown in FIG. 6B, in a small size in, for example, the center part of the screen.

If a high-luminance image 320 of the small size is displayed in the same part of the screen for a long term, the activating time of the high-luminance pixels defining the image 320 will differ from the activating time of the pixels surrounding the image 320, and the activating time of the backlight elements in the region of the image 320 will differ from the activating time of the backlight elements in the region surrounding the high-luminance image 320. Consequently, the screen of the display 300 has a conspicuous line, in some cases, at the boundary between the part where the high-luminance image 320 is displayed and the part where no high-luminance images are displayed. In view of this, the television receiver 100 is designed to move the region of the image 320 of the small size on the screen as shown in FIG. 6B, FIG. 6C or FIG. 6D. The image 320 may be moved at various times, for example, when an advertisement starts, or when a prescribed period is passed, or when a prescribed period is passed then an advertisement starts.

Further, the size of the image 320 displayed can be more reduced as shown in FIG. 6E, for the purpose of saving power.

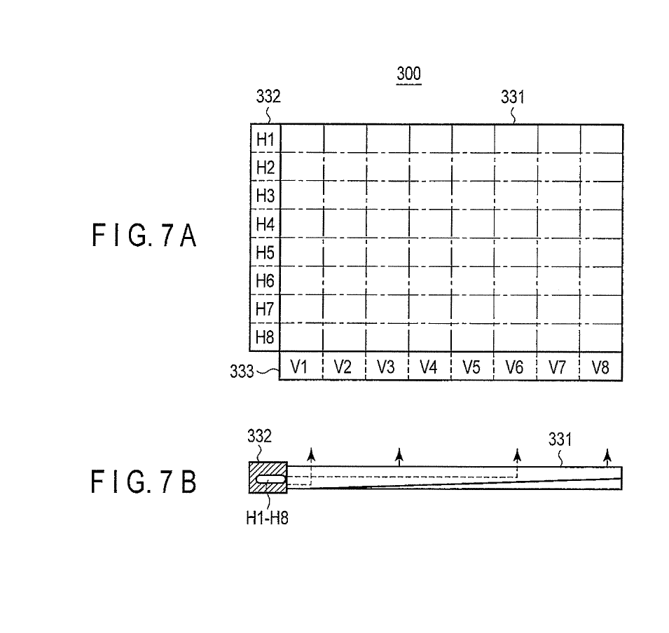

FIG. 7A and FIG. 7B show the structure of the backlight unit of the display 300, which can change the position and size of the display area of the display 300. The display 300 has a light guide plate 331. The backlight unit has horizontal light source elements 332 and vertical light source elements 333. The light beams emitted from the light source elements 332 and 333 are reflected in the light guide plate 331 and guided toward the front surface of the light guide plate 331, thus functioning as a backlight. The light source elements 332 and 333 are, for example, light-emitting diodes (LEDs). The light beams emitted from the light source elements 332 and 333 are diffused in the light guide plate 331. Therefore, light of uniform intensity emerges from the front surface of the light guide plate 331.

More specifically, the horizontal light source elements 332 are eight light sources H1 to H8, and the vertical light source elements 333 are eight light sources V1 to V8. If the light sources H1, H8, V1 and V8 are turned off, the peripheral part of the light guide plate 331 will appear dark. The boundary between the dark region and the bright region is not clear-cut. Nonetheless, the backlight region can be controlled.

Hence, in order to display such images 320 as shown in FIG. 6B to FIG. 6E, the signal processor 200 outputs a video signal so that the display 300 may display an image 320 surrounded by a dark frame at zero-luminance level. If the backlight unit of the display 300 operates, displaying such an image as shown in FIG. 6B, 6C, 6D or 6E, more power can be saved than otherwise.

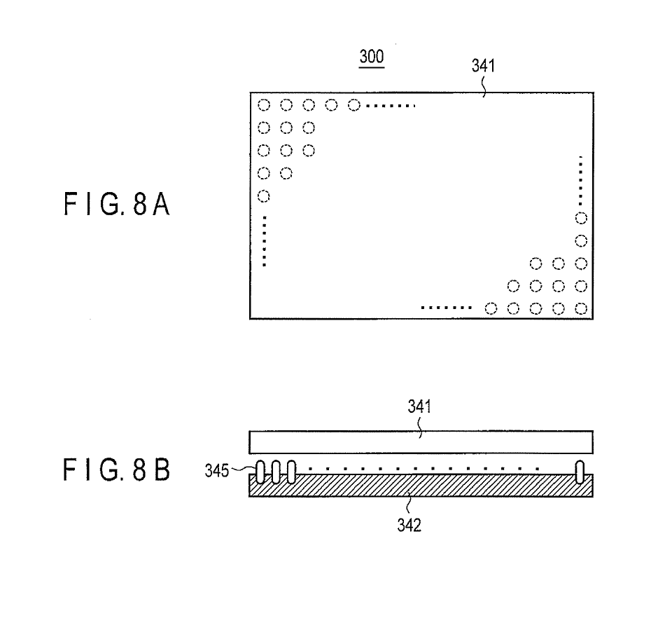

FIG. 8A and FIG. 8B show another structure the backlight unit of the display 300 may have. The display 300 has a glass substrate 341 and a substrate 342 arranged at the back of the glass substrate 341. On the substrate 342, light-emitting elements (LEDs) are arranged, in a two-dimensional pattern. The light-emitting elements can be turned on and off, in units of groups each consisting of the same number of light-emitting elements. A backlight drive circuit (not shown) can drive any selected group of light-emitting elements. A light diffusion layer is formed on the back of the glass substrate 341, and light therefore emerges from the glass substrate 341 with uniform intensity. As a result, the boundary between any bright region and any dark region is not always clear on the entire glass substrate 341. The backlight region can be controlled, nevertheless.

In order to display such an image 320 as shown in FIG. 6B, 6C, 6D or 6E, the signal processor 200 outputs a video signal containing data representing a dark frame at zero-luminance level. If the display 300 displays an image 320 of this type (shown in FIG. 6B, 6C, 6D or 6E), its backlight unit consumes less power than otherwise.

The backlight unit of the display 300 is not limited to the configuration described above. The backlight unit may have a plurality of fluorescent lamps instead. Further, the number of segments into which the display region is divided is not limited to the number specified above. The number of segments can be changed as needed, in the same manner as described above.

As stated above, the backlight region can be controlled. In order to save power, the backlight region may be controlled in terms of illumination intensity, thereby to save power. To be more specific, the illumination intensity of the entire backlight region may be decreased, in order to reduce the power consumption in the backlight unit. The illumination intensity of the backlight region may be changed to various values in step by step. Moreover, the backlight region can, of course, be changed in both size and illumination intensity.

Displays having a large screen have been developed for use in television receivers. The light sources used in these displays are, for example, fluorescent lamps or light-emitting elements (e.g., LEDs, organic electroluminescent diodes or plasma display).

To save power in the large-screen display of the television receiver will greatly contribute to power saving in society. To switch the reception state of the television receiver, from the full-segment receiving state to the one-segment receiving state, will also save much power.

The television receiver 100 can perform the operations described above. More precisely, the television receiver 100 can perform various combinations of operations, in accordance with the application program provided in the control block 400.

In the one-segment receiving state, the control block 400 can set the display 300 supplied with the video signal output from the signal processor 200, to a full-screen display state. In another embodiment, the control block 400 can, in the one-segment receiving state, set the display 300 supplied with the video signal output from the signal processor 200, to a partial-screen display state, and then turn off some of the light-emitting elements of the backlight unit. In still another embodiment, the control block 400 can, in the one-segment receiving state, set the display 300 supplied with the video signal output from the signal processor 200, from the full-screen display state to the partial-screen display state, and then turn off some of the light-emitting elements of the backlight unit, when the power in the battery 553 decreases to a prescribed value. In another embodiment, the control block 400 can, in the one-segment receiving state, set the display 300 supplied with the video signal output from the signal processor 200, to the full-screen display state or the partial-screen display state, and turn off some of the light-emitting elements of the backlight unit, thereby to set the display 300 to one display state in response to the selection signal the user has input. Further, the display 300 can display a message, prompting the user to operate the remote controller 700.

Moreover, in another embodiment, the tuner 110 can receive a broadcast signal from the external antenna 101 and the power output circuit 500 can supply power to the booster 102 of the external antenna 101, if the reception state has been set to the one-segment receiving state. In still another embodiment, the tuner 110 can receive the broadcast signal from the external antenna 101 and the power output circuit 500 can stop supplying power to the booster 102 of the internal antenna 105, if the reception state has been set to the one-segment receiving state. In a further embodiment, tuner 110 can receive a broadcast signal from the attached antenna and the power output circuit 500 can stop supplying power to the booster 102 of the external antenna 101, if the reception state has been set to the one-segment receiving state. In any of these cases, the antenna may be switched automatically, or the user may switch the antenna in accordance with the instruction the display 300 shows.

Moreover, in still another embodiment, the image 320 shown in FIG. 6A to FIG. 6E can be changed in size in accordance with the power remaining in the battery 553 or in response to an instruction the user has input. In addition, the audio-system circuits may be turned off, while keeping the video signal active, thereby to save power. Conversely, the video-system circuits may be turned off, while keeping the audio signal active, thereby to save power.

The television receiver 100 according to any one of the embodiments described above can save power, while performing all of its functions. Further, even upon a blackout, the television receiver can save power, while performing all of its functions. Moreover, the television receiver 100, which has not only ordinary functions, but also a power-saving function, may be bought by consumers willing to save power, ultimately reducing the power consumption in society.

In order to save power, the display 300 may be controlled to set at least one-third (⅓) of the screen of the display 300 to low luminance in the one-segment receiving state, and display the image in the remaining part of the screen. In this case, those of the light-emitting elements of the backlight unit, which lie behind one-third (⅓) of the screen, are turned off. Moreover, the image so displayed can move, with time, over the entire screen. Said remaining part of the screen can be changed in size in accordance with how much power should be saved in the television receiver 100.

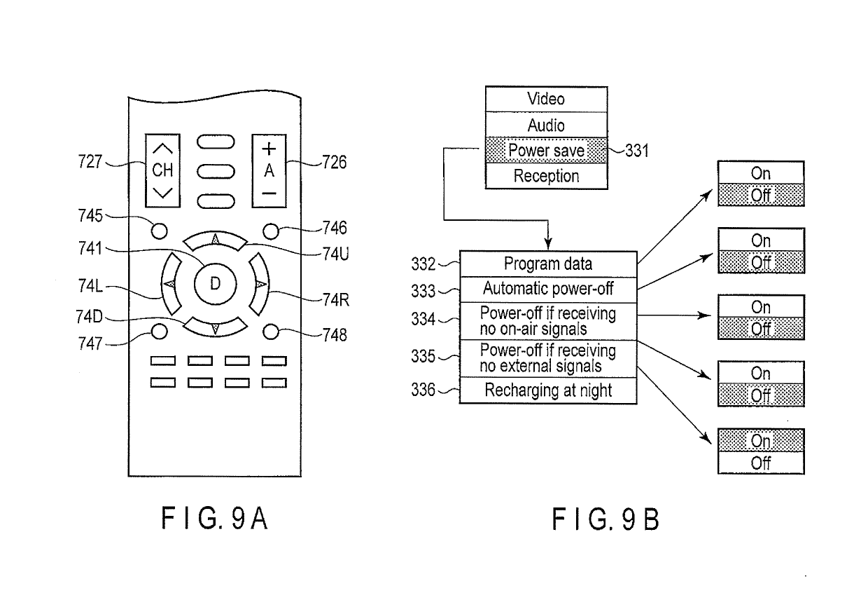

FIG. 9A shows the remote controller 700 having various buttons, and FIG. 9B shows an exemplary power-saving menu the user may use to save power in the television receiver 100. If the user pushes the quick menu button 733, the display 300 displays the quick menu showing four items, i.e., “video setting”, “audio setting”, “power-save setting” and “receiver setting”. The user pushes the button 74U or button 74D, moving the cursor to the desired item, and then pushes the select button 741, selecting the desired item. Assume that the user moves the cursor to, for example, the power-save setting 331 and then pushes the select button 741. Then, the display 300 displays the menu of the next layer, which consist of “program data acquisition”, “automatic power-off”, “off to no on-air signal”, “off to no external input” and “battery recharging at night”. If the user selects one of these menu items, the display 300 displays an on-button and an off-button beside the menu item selected.

If the user moves the cursor to, for example, “program data acquisition (EPG data)”, an on-button and an off-button are displayed beside “program data acquisition”. The user operates the button 74U or 74d, moving the cursor to, for example, “on-button”, and then pushes the select button 741. In this case, the television receiver 100 acquires a digital broadcast program while the power switch of the television receiver 100 remains off. (that is, while the receiver 100 remains in the standby state). If the user selects “off-button”, the television receiver 100 will acquire no program data.

Assume that the cursor is moved to “automatic power-off”. Then, an on-button and an off-button are displayed beside “automatic power-off”. The user operates the button 74U or 74d, moving the cursor to, for example, “on-button”, and then pushes the select button 741. In this case, the television receiver 100 stops receiving power and is turned off, assuming the standby state, if it remains not operated at all for three hours. If the user selects “off-button”, the television receiver 100 keeps receiving power even if it remains not operated at all for three hours.

Further assume that the cursor is moved to “off to no on-air signal”. Then, an on-button and an off-button are displayed beside “off to no on-air signal”. The user operates the button 74U or 74d, moving the cursor to, for example, “on-button”, and then pushes the select button 741. In this case, the television receiver 100 stops receiving power, and assumes the standby state if it receives no broadcast signals for about 15 minutes. If the user selects “off-button”, the television receiver 100 keeps receiving power even if it keeps receiving no signals.

Assume that the cursor is moved to “off to no external input”. Then, an on-button and an off-button are displayed beside “off to no external input”. The user operates the button 74U or 74d, moving the cursor to, for example, “on-button”, and then pushes the select button 741. If the television receiver 100 keeps receiving no signals for 15 minutes in an external-input selecting mode, the television receiver 100 stops receiving power, and assumes the standby state. If the user selects “off-button”, the television receiver 100 keeps receiving power even if it keeps receiving no signals.

Assume that the cursor is moved to “battery recharging at night”. Then, an on-button and an off-button are displayed beside “battery recharging at night”. The user operates the button 74U or 74d, moving the cursor to, for example, “on-button,” and then pushes the select button 741. In this case, the battery 553 is automatically recharged, for example, from 10:00 PM to 9:00 AM (if the television receiver 100 is in the standby state). If the user moves the cursor to “off-button” and pushes the select button 741, the battery 553 is set to be recharged when the television receiver 100 is in the standby state.

The television receiver 100 described above can be controlled to save power, as the user operates the mobile terminal 800, as will be explained below.

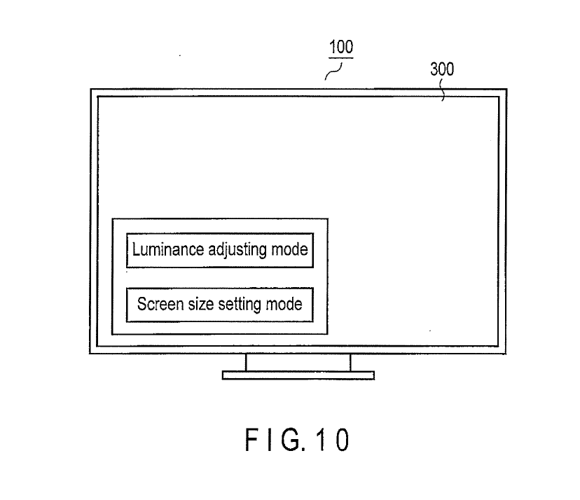

FIG. 10 is a diagram showing an exemplary setting menu the display 300 of the television receiver of FIG. 1 may display, helping the user to set the television receiver 100 to a power-save mode and/or peak-shift mode. The television receiver 100 according to the embodiment can be set to the operation of the power-save mode and/or the peak-shift mode. That is, the user can select the operation of power-save mode and/or the peak-shift mode. In the power-save mode and/or the peak-shift mode, the luminance may be decreased to save power, and/or the image size may be reduced to save power. More specifically, the user may move the cursor to “luminance adjusting mode” and/or “image-size setting mode” displayed by the display 300, and push the select button 741. As a result, the television receiver 100 is set to the power-save mode and/or peak-shift mode. The display 300 may display another choice of “luminance/image-size setting mode”, in addition to “luminance adjusting mode” and “image-size setting mode”.

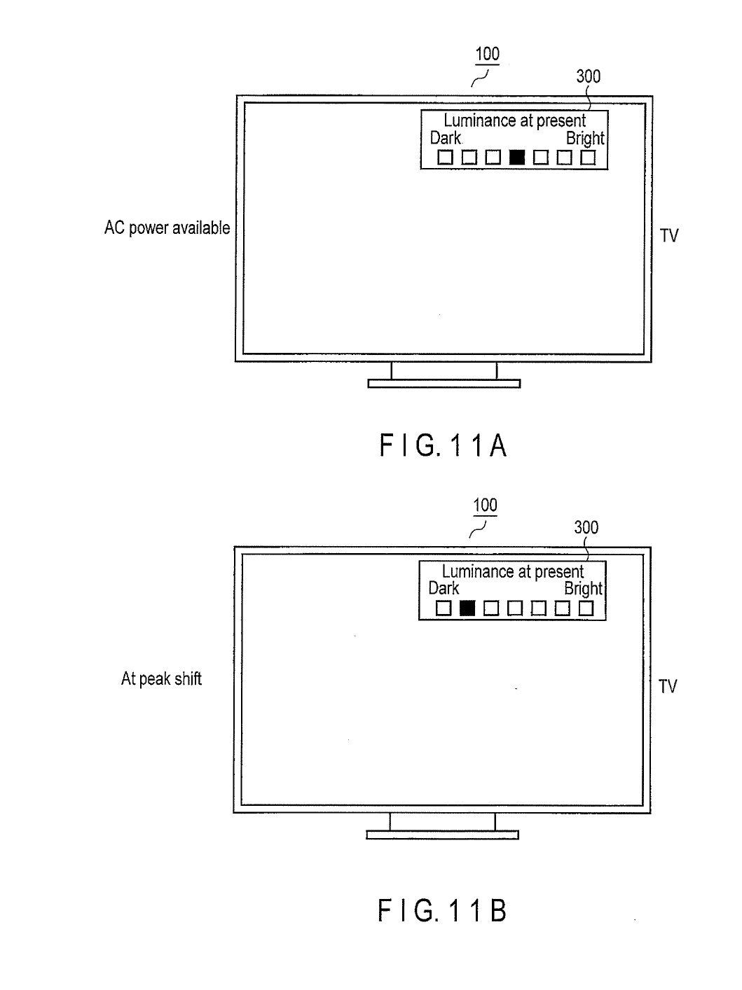

FIGS. 11A and 11B show two luminance indicators, respectively. When the television receiver 100 starts operating on the commercially available AC power or when a channel switching is performed while the television receiver 100 is operating on commercially available AC power, the display 300 displays the luminance indicator of FIG. 11A, which indicates where the luminance level lies between the maximum value (bright) and the minimum value (dark). The indicator shown in FIG. 11A indicates a luminance of intermediate level. When the television receiver 100 is set to the peak-shift mode, the display 300 displays the luminance indicator of FIG. 11B. The indicator shown in FIG. 118 indicates luminance of the second darkest level.

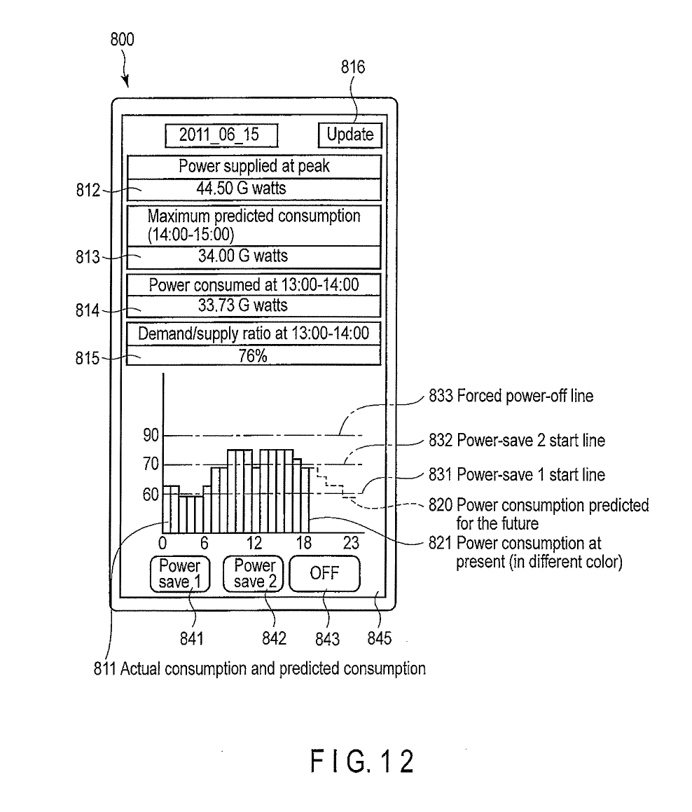

FIG. 12 shows the mobile terminal 800. The mobile terminal 800 can acquire actual consumption data (hereinafter called “actual consumption data”) and predicted power consumption data (hereinafter called “predicted consumption data”, i.e., power demand) from the power-supply control system of, for example, an electric power company or a power management organization, either data showing how the value changes hour by hour during one day. The mobile terminal 800 can analyze the changes in these data and display a graph 811 representing the results of the analysis. The graph 811 is, for example, a bar graph. In the graph, the time of the day is plotted on the X axis, the bars indicate the actual and predicted consumptions, and the ratio of the power consumption to the power supply (hereinafter called “demand/supply ratio”) is plotted on the Y axis. The demand/supply ratio is indicated as a percentage. The unit is not limited to percentage. Further, the actual power consumption and the predicted power consumption may be shown in kilowatts.

Moreover, the mobile terminal 800 displays power-save start lines crossing the bars. The power-save start lines can be moved up and down in accordance with a control signal. The user may use the power-save start lines, so adjusted in position, as guidance for taking any power-saving measures. In the case shown in FIG. 12, three power-save lines are displayed, i.e., power-save 1 start line 831, power-save 2 start line 832, and forced power-off line 833. The power-save 1 start line 831, power-save 2 start line 832 and forced power-off line 833 are set at, for example, the demand/supply ratios of 60%, 70% and 90%, respectively. The positions of these lines are converted to power-save start values on the basis of, for example, the predicted consumption data. If the predicted power consumption exceeds the value at which to start power saving, either at present or one to three hours later, the mobile terminal 800 transmits a power-save command signal to the apparatus in which to save power, i.e., television receiver 100. The power-save command signal is associated with the power-save 1 start line 831, power-save 2 start line 832, or forced power-off line 833. In response to the power-save command signal, the television receiver 100 assumes the power-save 1 mode, the power-save 2 mode or the forced power-off mode.

The mobile terminal 800 further displays the peak power supply 812 for the day, predicted maximum power supply 813, actual power consumption 814 for a specific time slot (e.g., 13:00-14:00), and rate of power consumption/supply rate 815 for the specific time slot.

The mobile terminal 800 also displays an update button 816 for acquiring the actual consumption data and the predicted consumption data. If the user touches the update button 816, the mobile terminal 800 accesses the server 611, acquiring the latest actual consumption data and the latest predicted consumption data.

Still further, the mobile terminal 800 displays a power-save 1 button 841, a power-save 2 button 842, and a forced power-off button 843. When the user touches the buttons 841, 842 and 843, the mobile terminal 800 transmits, by radio, power-save command signals to the television receiver 100. If the user touches the power-save 1 button 841, the mobile terminal 800 transmits a command signal designating the power-save 1 mode to the television receiver 100, setting the television receiver 100 to the power-save 1 mode. If the user touches the power-save 2 button 842, the mobile terminal 800 transmits, by radio, a command signal designating the second power saving to the television receiver 100, setting the television receiver 100 to the power-save 2 mode. If the user touches the forced power-off button 843, the mobile terminal 800 transmits, by radio, a forced power-off command signal to the television receiver 100.

The power-save 1 mode and the power-save 2 mode can be set independently of each other, or in combination with each other, as explained with reference to FIGS. 3 to 5, FIGS. 6A to 6E, and FIGS. 7A and 7B. In other words, the television receiver 100 can be set to various power saving modes. In any power-save mode, the backlight can be set to the standard brightness, intermediate brightness and low brightness.

The background to the buttons 841, 842 and 843 assumes a color associated with the power-save mode to which the television receiver 100 is set or will be set. For example, the background color is blue while the receiver 100 remains in the standard operating mode (in no power-save mode), is green while the receiver 100 remains in the power-save 1 mode, and is yellow while the receiver 100 remains in the power-save 2 mode, and is red while the receiver 100 remains in the power-off mode. Perceiving the background color, the user can instantly know which mode the television receiver 100 now assumes.

Moreover, the mobile terminal 800 displays line-position adjusting buttons (not shown) and a line-position select button (not shown), which may be used to adjust the position of the power-save start lines 831 and 832, etc. at the desired positions.

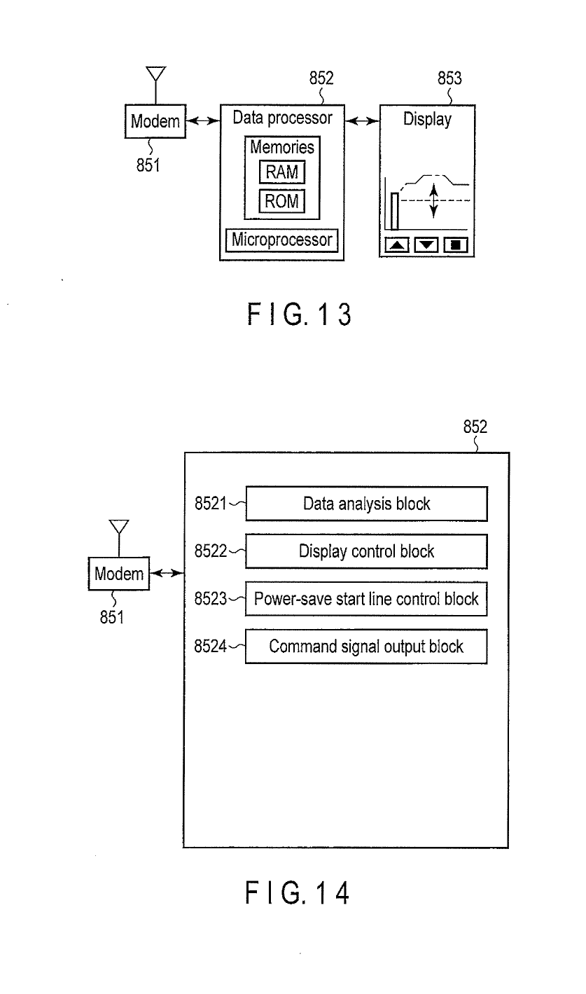

FIG. 13 shows the configuration of the mobile terminal 800. The terminal 800 comprises a transceiver (modem) 851, a data processor 852, and a display 853. The modem 851 can perform communication with a base station and the television receiver 100. To acquire the actual consumption data and predicted consumption data, the mobile terminal 800 access the server 611 via the base station or the television receiver 100.

The data processor 852 analyzes and processes the data acquired from the server 611, generating display data representing the image shown in FIG. 12. The display data is supplied to the display 853, which displays the image represented by the display data.

The display 853 also display various buttons the user may touch as described above. The data processor 852 includes memories (including a RAM and a ROM) and a microprocessor. The data processor 852 performs various functions described in the application programs, some stored in it and/or others downloaded from an external apparatus.

The display 853 displays line-position adjusting buttons and a line-position select button (not shown). The line-position adjusting buttons are used to move the power-save start lines 381 and 382 to desired positions. The line-position select button is used to set the lines at the desired positions.

FIG. 14 shows the function blocks incorporated in the data processor 852, i.e., data analysis block 8521, display control block 8522, power-save start line control block 8523, and command signal output block 8524. The data analysis block 8521 analyzes the actual consumption data and the predicted consumption data and converts them to display data. The display control block 8522 displays a graph, power-save start lines, and buttons the user may touch. The power-save start line control block 8523 adjusts the positions of the power-save start lines as the user touches the buttons.

The command signal output block 8524 outputs a power-saving command signal when the user touches the power-save 1 button 841 or power-save 2 button 842 or forced power off button 843.

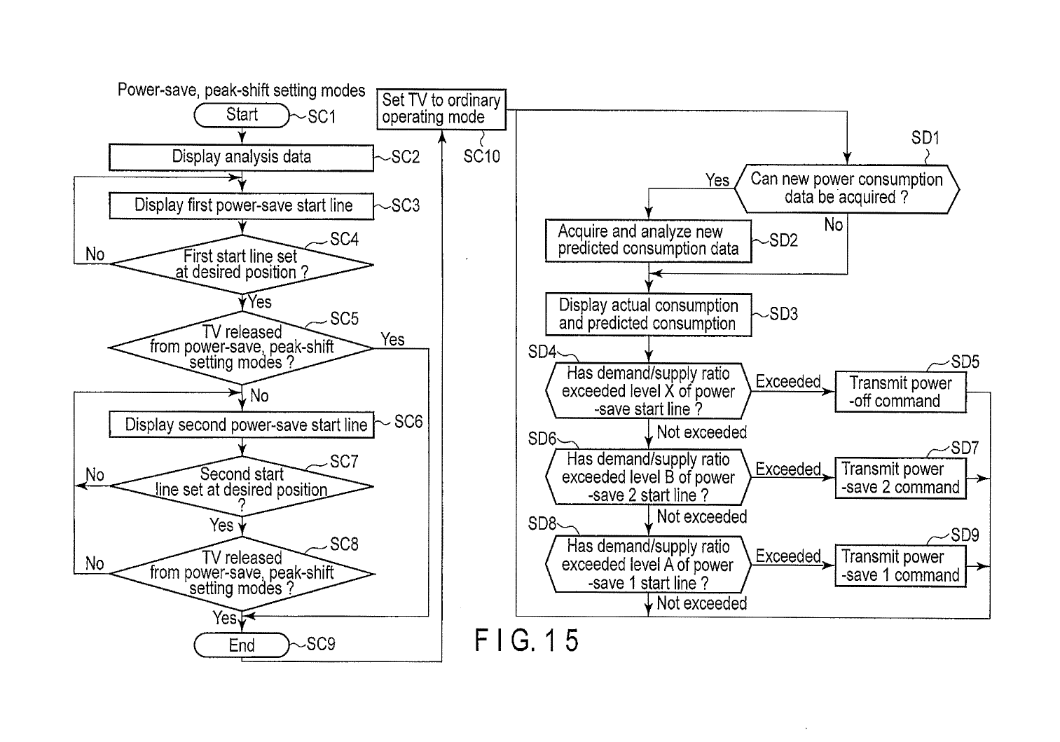

FIG. 15 shows how the mobile terminal 800 analyzes the actual consumption data and the predicted consumption data, adjusts the positions of the power-save start lines (including the power off line) and generates a power-saving command signal.

First, the actual consumption data and the predicted consumption data are analyzed (Step SC1). Then, the result of the analysis is displayed (Step SC2). Next, the power-save 1 start line 831 is displayed (Step SC3). At this point, the power-save 1 button 841 is changed in color or made to blink, showing that the line is the power-save 1 start line 831. The user may touch the buttons, thereby to move the power-save 1 start line 831 up or down, crossing the bars of the graph. When the power-save 1 start line 831 moves to a desired position, the user touches the line-position select button, setting the start line 831 at the desired position (not shown) (Step SC4). The power-save 1 start line 831 may be set at, for example, the demand/supply ratio of 60%. In this case, the mobile terminal 800 transmits the first power-saving command signal to the television receiver 100 if the demand/supply ratio ups to 60%.

The mobile terminal 800 then asks the user whether the television receiver 100 should be released from the power-save mode setting state and peak-shift mode setting state (Step SC5), and displays an “end” button. If the user touches the “end” button (Step SC9), the television receiver 100 is set to the ordinary operating mode (Step SC10). If the user does not touch the “end” button in Step SC5, the next power-save start line is displayed upon the lapse of a prescribed time (Step SC6). The next power-save start line is, for example, the power-save 2 start line 832. This power-save start line can also be adjusted in position, or can be set at a desired position when the select button is touched. Thus, the power-save start lines are set, one after another.

In the ordinary operating mode, it is determined whether new power consumption data (i.e., new actual consumption data and new predicted consumption data) can be acquired (Step SD1).

If new predicted consumption data has been acquired, this data is analyzed (Step SD2). If new power consumption data has not been acquired, the data acquired previously is used. A graph showing both the actual power consumption and the predicted power consumption is prepared on the basis of the predicted consumption data (Step SD3). This graph is not displayed at all times, but only if the user touches, for example, a “power-supply forecast” button.

As the time passes, it is determined whether the demand/supply ratio exceeds the level X of a power-save start line (e.g., level at which the power supply to the television receiver 100 should be stopped), in the present time slot and in a following period of a few hours (Step SD4). If the demand/supply ratio exceeds the level X, the mobile terminal 800 transmits a power-off command (Step SD5). If the demand/supply ratio does not exceed the level X, it is determined whether the demand/supply ratio exceeds the level B of, for example, the power-save 2 tart line (Step SD6). If the power demand/supply ratio exceeds the level B, the mobile terminal 800 transmits a power-save 2 command to the television receiver 100 (Step SD7). If the demand/supply ratio does not exceed the level B, it is determined whether the demand/supply ratio exceeds the level A of, for example, the power-save 1 start line (Step SD8). If the demand/supply ratio exceeds the level A, the mobile terminal 800 transmits a power-save 1 command to the television receiver 100 (Step SD9). If the demand/supply ratio does not exceed the level A, the television receiver 100 remains in the standard operating mode.

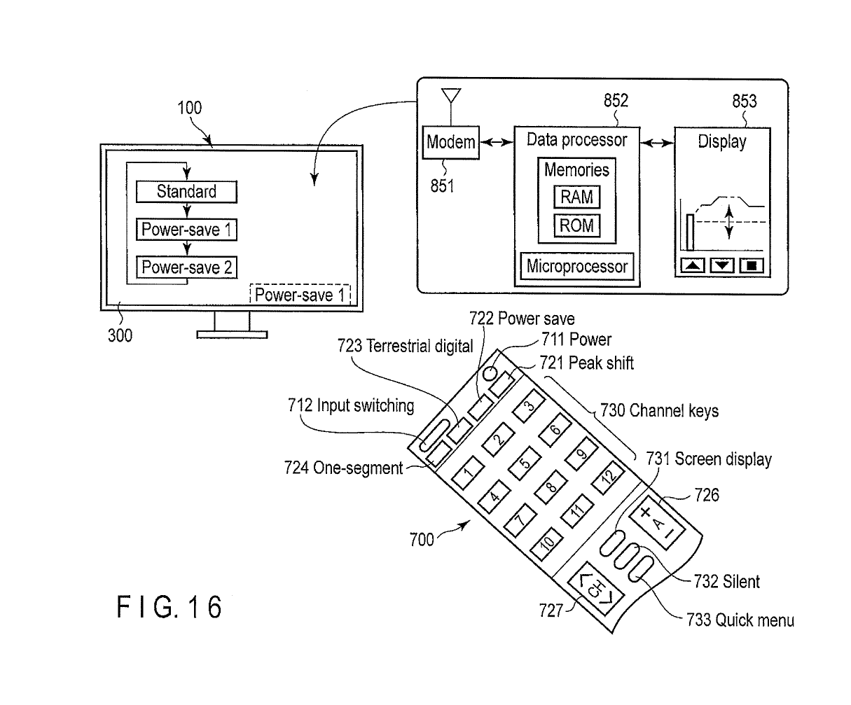

FIG. 16 shows another embodiment, in which the television receiver 100 incorporates the functions of the transceiver 851, data processor 852 and display 853. The transceiver 851 is equivalent to the transceiver 460 shown in FIG. 1, the data processor 852 is equivalent to the control block 400 shown in FIG. 1, and the display 853 is equivalent to the display 300 shown in FIG. 1. With this embodiment, the user can set the positions (levels) of the power-save start lines, etc. by operating the remote controller 700.

In order to save power in the television receiver 100, the user pushes the power-save button 722 of the remote controller 700, generating a power-save 1 command, a power-save 2 command or the like. For example, as the user repeatedly pushes the power-save button 722, the standard operating command, power-save 1 command and power-save 2 command are generated in the order mentioned. More specifically, as the user pushes the power-save button 722, icons of “Standard,” “Power-Save 1” and “Power-Save 2” are displayed in the order mentioned, on the screen of the display 300. If the user pushes the select button 741 while any icon is being displayed, the television receiver 100 will be set to the power-save mode associated with the icon. The power-save 1 command and power-save 2 command set the television receiver 100 to the power-save mode explained with reference to FIG. 9, or the power-save mode explained with reference to FIG. 3, FIGS. 4A to 4C, FIG. 5, FIGS. 6A to 6E, and FIGS. 7A and 7B, or a combination of the power-save modes. The television receiver 100 is not fixed in one power-save mode. In whichever power-save mode the television receiver 100 is set, the backlight may be set at the standard brightness, brightness a little lower than the standard value, or brightness much lower than the standard value.

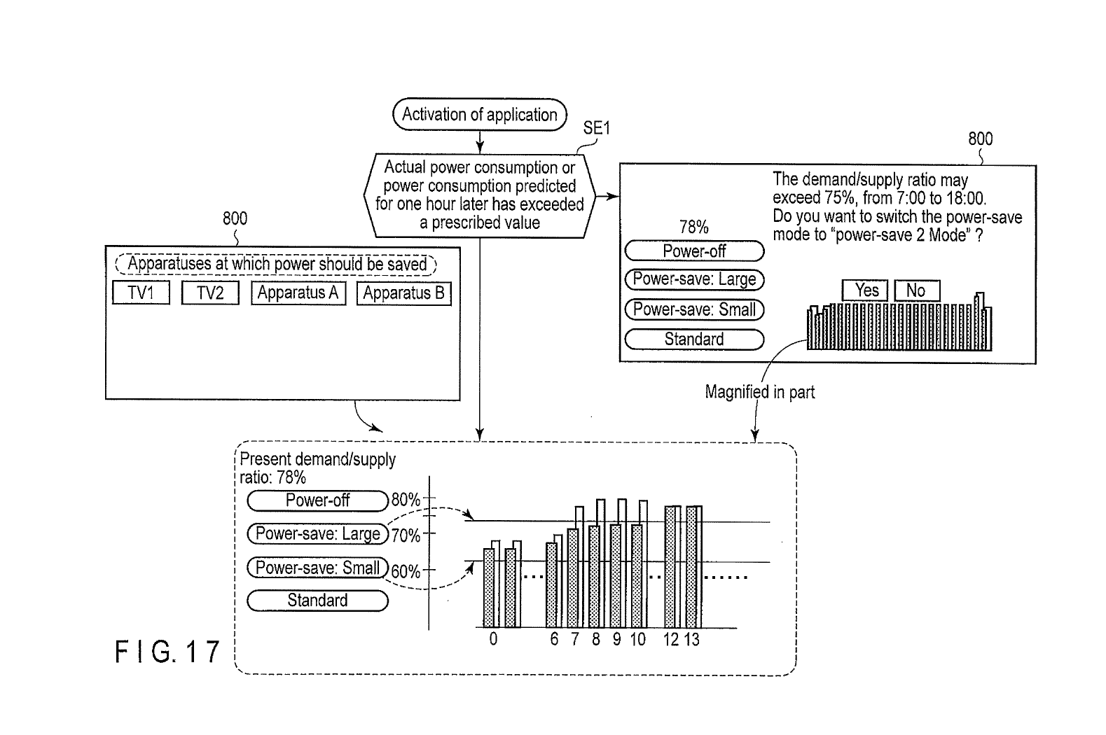

FIG. 17 shows how the mobile terminal 800 operates when an application program for checking the power consumption is activated in the mobile terminal 800 to check the power-saving state. The application program is described to control the command signal output block. It is possible to this application program can be automatically activated at intervals. Alternatively, it can be activated when the user selects it in the menu. The application program for checking the power consumption causes the display 853 to display an alarm or power-saving instructions, if the actual current power consumption or the power consumption predicted for one hour later has exceeded the prescribed value. Assume that the power-save 1 mode (small saving) and the power-save 2 mode (large saving) correspond to a demand/supply ratio of 63% and a demand/supply ratio of 75%, respectively. Further assume that the demand/supply ratio calculated from the predicted consumption data exceeds 75% for the time slot of 7:00 to 18:00.

In the above case, the mobile terminal 800 displays a message of, for example, “The demand/supply ratio may exceed 75%, from 7:00 to 18:00. Do you want to switch the power-save mode to “power-save 2 mode?” At this point, the mobile terminal 800 also displays two buttons “Yes” and “No.” The user easily selects and touches either the “Yes” button or the “No” button.

Thus, when the predicted demand/supply ratio exceeds a specific value in the future, the user of the terminal 800 is motivated to save power in the television receiver 100. This can prevent a blackout.

This embodiment can achieve power saving not only in television receivers, but also in other household apparatuses such as air conditioners, illumination devices and refrigerators.

As described above, when the predicted demand/supply ratio exceeds a specific value, the user is motivated to save power in the television receiver 100. The demand/supply ratio may be generated not only under referring the predicted consumption data, but also under referring the weather forecast data. The weather forecast data is acquired from a meteorological service server via, for example, the Internet or a base station.

On a fine day in summer, the temperature is predicted to rise in the afternoon. In the afternoon, air conditioners and electric fans may be used in many houses. The predicted demand/supply ratio is therefore set and corrected to a large value, and predicted consumption data is generated on the basis of the predicted demand/supply ratio so set. In this case, the display 853 displays an alarm or power-saving instructions, long before the temperature rises as predicted. On a cloudy day in winter, the weathercaster says that the temperature will fall due to a cold spell, and air conditioners are used in many houses. In this case, the display 853 displays an alarm or power-saving instructions, long before the temperature falls as predicted.

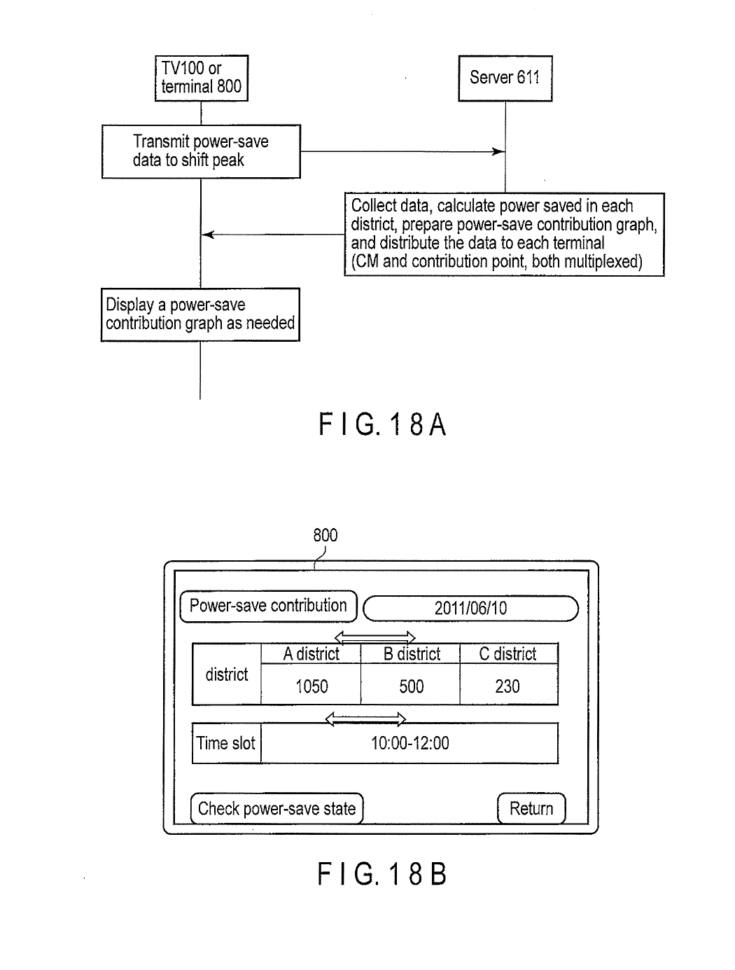

FIG. 18A shows a system that uses power-save data if power can be saved in, for example, the television receiver 100. In the system, the mobile terminal 800 or the television receiver 100 can transmit power-saving data (e.g., demand/supply ratio or power consumption), as a reference value, for power-save 1, power-save 2 or power-off, to the server 611. The server 611 receives such reference values from the houses existing in several districts. The server 611 compiles the reference values for the respective districts, and calculates the power saved in each district. The server 611 then generates graph data representing how much the district has contributed to power saving, and distributes the graph data to all mobile terminals used in the district. At this point, an advertisement image may be transmitted to every mobile terminal in the district. The mobile terminal 800 receives the graph data. The mobile terminal 800 displays a menu including “Power-Save Contribution.” If the user touches this item, the mobile terminal 800 displays the graph. The graph shows the ratio at which each district has contributed to power saving, with respect to the power saved in all districts.

This embodiment also may contribute to power saving, motivating the user to save power in the television receiver 100, thereby to save electric power in the district.

“Contribution to power saving” can be expressed in various forms. It is a “numerical value” showing how many electronic apparatuses are set to a power-save mode in a district. Alternatively, it may be a “numerical value” showing how many electronic apparatuses are set to power-save mode in a time slot. Still alternatively, it may be a “numerical value” showing how many electric apparatuses are set to power-save mode in a district in a specific time slot. Further, “Contribution to Power Saving” may be watts saved roughly calculated from the power-saving level, and the watts saved in each district or in each time slot, or in each district in a specific time. FIG. 18B shows the “Contribution to Power Saving” the mobile terminal 800 displays when the user touches a power-saving state check button. The mobile terminal 800 displays A, B and C districts, and the numbers of apparatuses set in power-save mode in A, B and C districts, respectively, in the time slot of 10:00 to 12:00. To know how many apparatus are set to power-save mode in any other district, the user only needs to touch “District” displayed and slide his or her finger leftward or rightward, whereby the number of apparatuses in power-save mode in the other district is displayed. To know how many apparatus are set to power-save mode in any other time slot, the user only needs to touch “Time Slot” displayed and slide his or her finger leftward or rightward, whereby the number of apparatuses in power-save mode in the other time slot is displayed. Moreover, the user may change the date to another date. In this case, the mobile terminal 800 displays “Contribution to Power Saving” for the other date.

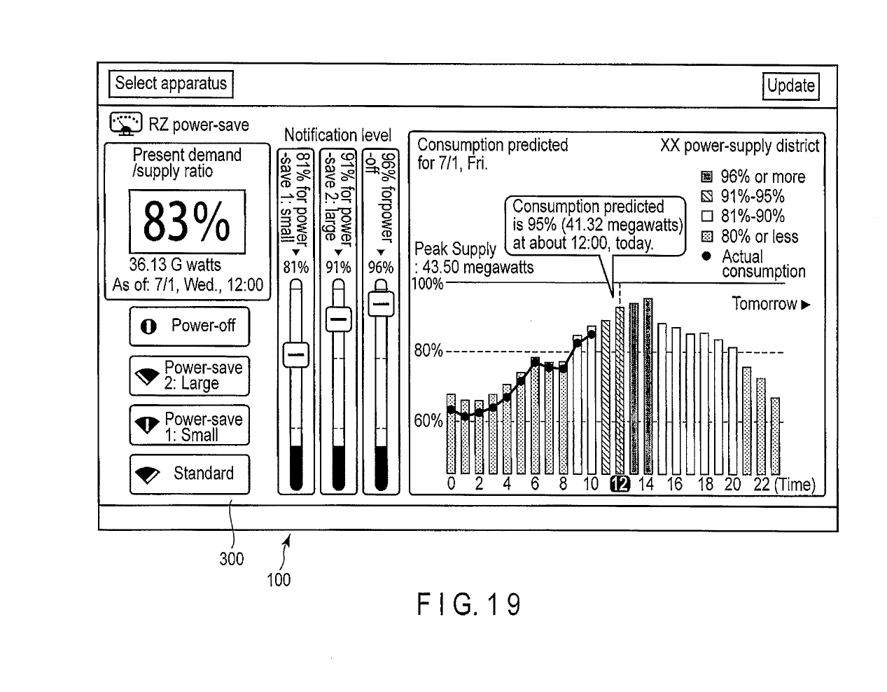

FIG. 19 is shown to explain how the user operates the mobile terminal 800 or the television receiver 100 in accordance with a power-consumption predict data (including actual consumption data and predicted consumption data) displayed by the display of the mobile terminal 800 or the display of the television receiver 100.

Herein after, the display 300 is referred. The display 300 displays the power-consumption present data in the left half of the screen. The report shows the present demand/supply ratio of 83%, the present power consumption of 36.13 Giga watts, and the power-saving items selected now. The power-saving items are: “Power-Off,” “Power-Save 2: Large,” “Power-Save 1: Small” and “Standard” One of these power-saving items is highlighted, indicating the power-saving status the television receiver 100 assumes at present.

The display 300 further displays three vertical slider bars, indicating three reference levels for outputting a power-off command signal, a power-save 1 command signal and a power-save 2 command signal, respectively. On the right of the slider bars, a bar graph is displayed, which shows the predicted power consumption. In the bar graph, the time of the day is plotted on the X axis, and the line connecting black dots shows how the demand/supply ratio has changed thus far.

If operated, the mobile terminal 800 may transmit a command signal to set the power-supply state of the television receiver 100 to Power-Off, Power-Save 2: Large, Power-Save 1: Small or Standard. In this regard, some kind of the references (i.e., specific demand/supply ratios) are required for Power-Off, Power-Save 2: Large, Power-Save 1: Small or Standard, respectively. These references are set as will be explained below.

Three cursors are displayed on the slider bars, respectively. The cursors can be moved up and down, each to set a demand/supply ratio ranging from 50% to 100%.

The lower position of the left slider bar, which indicates a demand/supply ratio of 54% is grayed. Similarly, the lower positions of the middle and right slider bars, which indicate demand/supply ratios of 55% and 56%, respectively, are grayed. These cursors cannot be moved down into the gray parts of the slide bars. The cursors may be moved in a so-called ‘touch-pad scheme,” or in a combined scheme of highlight display and button manipulation. The highlight position can be changed by manipulating a button. The button used is, for example, the arrow-mark button and the select button, either provided on the remote controller 700 described above.

<Safety Zone where Standard User is Never Alerted to Select Power-Save 1: Small>

The values set at the slider bars must satisfy all the following relations:

A≧55, A<B<C, B≧A+1, and C≧B+1,

where A is the demand/supply ratio for Power-Save: Small, B is the demand/supply ratio for Power-Save 2: Large, and C is the demand/supply ratio for Power-Off.

The initial values A, B and C set at the slider bars are 81%, 91% and 96%, respectively. Any demand/supply ratio less than 81% is considered as standard.

<Automatic Specification>

The television receiver 100 according to this embodiment does not use a setting screen, such as an automatic-mode screen or manual-mode screen. This is because such an additional setting screen requires an addition operating step.

Value Y valid before the remote controller 700 transmits a command signal is cached. The cache can be updated every time the remote controller 700 transmits a command signal. Value Y is a code. If Y=0001, it indicates “execute Standard.” If Y=0010, it indicates “execute Power-Save 1: Small.” If Y=0100, it indicates “execute Power-Save 2: Large.” If Y=1000, it indicates “execute Power-Off.”

The intermediately preceding value is recorded or not recorded, in accordance with which remote command has been executed, because the user may correct the level notified. That is, the intermediately preceding value is rewritten if any slider bar is adjusted or if the remote controller 700 is operated, and is never rewritten in any other case.

In this embodiment, when the television receiver 100 is activated by the application program or released from the suspended state, the data about power saving is checked, such decision as described below is made, and such an alert as describe below is generated to the user.

First, the television receiver 100 acquires the latest power-saving data X (i.e., demand/supply ratio). If X<55, the display 300 displays the latest application menu, and the television receiver 100 automatically starts operating.

If 55≦x<A and if Y=0001, the television receiver 100 displays the latest application menu, without generating alerts, and automatically starts operating. If X has any other value, the television receiver 100 displays a message of “Do you want Standard?”

If the user selects “Yes,” the television receiver 100 operates in the standard mode, displays the latest application menu, and then starts operating automatically. If the user selects “No,” the television receiver 100 immediately displays the latest application menu, and starts operating automatically.

If A≦X<B and if Y=0010, the television receiver 100 generates no alerts. Next, the television receiver 100 immediately displays the latest application menu, and starts operating automatically. Otherwise, the receiver 100 displays a message “Do you want Power-Save 1: Small?” prompting the user to select “Yes” or “No”.

If the user selects “Yes”, the television receiver 100 performs “Power-Save 1: Small”, and starts operating automatically. If the user selects “No”, the television receiver 100 displays the latest application menu and starts operating automatically.

If B≦X<C and if Y=0100, the television receiver 100 generates no alerts, displays no alerts and starts operating automatically. Otherwise, the television receiver 100 notifies “Power-Save 2: Large” and displays a message “Do you want Power-Save 2: Large?” prompting the user to select “Yes” or “No”.

If the user selects “Yes,” the television receiver 100 performs “Power-Save 2: Large” displays the latest application menu and starts operating automatically. If the user selects “No” the television receiver 100 displays the latest application menu and starts operating automatically.

If C≦C≦100, the television receiver 100 displays a message “Do you want “Power-Off?” prompting the user to select “Yes” or “No”.

If the user selects “Yes,” the television receiver 100 performs “Power-Off”. If the user selects “No”, the television receiver 100 displays the latest application menu and starts operating automatically.

After the television receiver 100 has started operating automatically, it performs various power-saving processes on specific conditions as set forth below, every time it acquires the latest data (X).

If Y=0001 (after starting Standard):
Nothing is performed if X<A.
“Power-Save 1: Small” is performed if A≦X<B.
“Power-Save 2: Large” is performed if B≦X<C.
“Power-Off” is performed if C≦X≦100.

If Y=0010 (after starting Power-Save 1: Small):
“Standard” is performed if X<A.
Nothing is performed if A≦X<B.
“Power-Save 2: Large” is performed if B≦X<C.
“Power-Off” is performed if C≦X≦C≦100.

If Y=0100 (after starting Power-Save 2: Large):
“Standard” is performed if X<A.
“Power-Save 1: Small” is performed if A≦X<B.
Nothing is performed if B≦X<C.
“Power-Off” is performed if C≦X≦100.

If Y=1000 (after starting Power-Off):
“Standard” is performed if X<A.
“Power-Save 1: Small” is performed if A≦x<B.
“Power-Save 2: Large” is performed if B≦X<C.
Nothing is performed if C X 100.

Even while the television receiver 100 is automatically operating, buttons for “Power-Off”, “Power-Save 2: Large”, “Power-Save 1: Small” and “Standard” can be selected, in priority, as the user operates the remote controller 700.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a transceiver configured to acquire actual consumption data and predicted consumption data for each time slot, from a power supply management system;
a data analysis block configured to analyze the actual consumption data and the predicted consumption data and to generate graph data representing a graph showing a result of the analysis;
a display control block configured to cause a display device to display the graph and a power-save start line in the graph;
a power-save start line control block configured to move the power-save start line to a desired position and to utilize a value associated with the desired position as a value at which to start power saving; and
a command signal output block configured to output a power-save command signal to an apparatus which should save power, if the actual consumption data and/or the predicted consumption data exceeds the value indicated by the power-save start line.

2. The electronic apparatus of claim 1, wherein the display control block causes the display device to display a power-saving button to be operated manually, and the command signal output block outputs a power-save command signal if the power-saving button is operated.

3. The electronic apparatus of claim 1, wherein power-save start line control block controls a plurality of power-save lines, thereby to set a plurality of power-saving start values.

4. The electronic apparatus of claim 3, wherein the display device displays a plurality of power-saving buttons associated with the power-save start lines, respectively.

5. The electronic apparatus of claim 1, wherein the display device has a display region whose background color changes if a power-save level is changed according to change of the predicted consumption data.

6. The electronic apparatus of claim 1, wherein the command signal output block cyclically outputs a plurality of power-save command signals for setting a different power-save start line as a prescribed button is operated repeatedly.

7. The electronic apparatus of claim 1, wherein the command signal output block checks power consumption in the apparatus which should save power, and causes the display device to display an alarm or a power-save message if the consumption at present or one hour later exceeds a predicted value.

8. The electronic apparatus of claim 1, which acquires data representing a power-saving level set for the apparatus which should save power.

9. The electronic apparatus of claim 8, which transmits the data acquired from the apparatus which should save power, to a server, and which displays analysis data transmitted from the server and representing how much power has been saved in the apparatus.

10. A method of saving power in an apparatus comprising a transceiver configured to acquire actual consumption data and predicted consumption data for each time slot, from a power supply management system, and a data processor configured to process data input from the transceiver, transmit signals via the transceiver and output a display signal to a display device,
wherein the data processor analyzes the actual consumption data and the predicted consumption data and generates graph data representing a graph showing a result of the analysis, causes a display device to display the graph and a power-save line in the graph, moves the power-save line to a desired position, utilizes a value associated with the desired position as a value at which to start power saving, and outputs a power-save command signal to the apparatus which should save power, if the actual consumption data and/or the predicted consumption data exceeds the value indicated by the power-save line.
